(19) United States
(12) Patent Application Publication
(10) Pub. No.: US 2017/0188589 A1
(43) Pub. Date: Jul. 6, 2017

(54) COMPOSITION AND PROCESS FOR MAKING MILLET-BASED FLOUR USEABLE IN FORMED FOOD PRODUCTS

(71) Applicant: UNIVERSITY OF CENTRAL OKLAHOMA, Edmond, OK (US)

(72) Inventors: Kanika BHARGAVA, Edmond, OK (US); Kritika SHAKYA, Edmond, OK (US)

(21) Appl. No.: 15/380,151

(22) Filed: Dec. 15, 2016

Related U.S. Application Data
(60) Provisional application No. 62/273,051, filed on Dec. 30, 2015.

(51) Int. Cl. A21D 2/18; A21D 8/00

(52) U.S. Cl. CPC A21D 2/186; A21D 2/181; A21D 8/00

(57) ABSTRACT

A formulation and process providing a method producing millet-based flour that binds together when combined with water, comprising: mixing finger millet flour and chickpea flour in approximately a 70 to 30 ratio w/w; matching the particle size of said millet flour and said chickpea flour by sieving through 60 mesh, adding sugar to said millet flour and chickpea flour in the range of 0.01% to 3% and preferably between 1.9% to 2.1% (of 100% of flour) to mask bitterness in the flavor of said millet; adding 10% to 20% starch from a gluten free source (rice, potato, tapioca) and preferably 15% (of 100% flour) of gelatinized starch to facilitate binding together of said millet flour and said chickpea flour when mixed with said water to form a dough and the dough kneaded.

### CROSS REFERENCES TO RELATED APPLICATIONS

This application claims the benefit of U.S. Provisional Patent Application No. 62/273,051 filed on Dec. 30, 2015 in the name of Kanika Bhargava and Kritika Shakya., which is expressly incorporated herein by reference in its entirety

### FIELD OF THE INVENTION

This invention pertains to flour-based food compositions made from millet. More particularly, this invention pertains to a composition and process for making gluten-free flour from millet which enables subsequent formation and cooking into a desired finished product.

### BACKGROUND OF THE INVENTION

According to World Health Organization's (WHO) global report (2016) in 2014, more than one in three adults over the age of 18 years were overweight and more than one in ten were obese worldwide. The prevalence of obesity is high in WHO Regions of America implied by the fact that the prevalence of obesity increased with increase in country's income level (WHO, 2016). In Regions of America alone in 2014, 62.8% males and 59.8% females were overweight. Overweight and obesity has been strongly linked to diabetes and the increasing prevalence of obesity has increased incidence of diabetes as well. According to WHO global report (2016) in 2014, there were over 422 million people with diabetes worldwide in comparison to 108 million in 1980 and is expected to reach 592 million by 2035. United States alone had more than 62 million people with diabetes (WHO, 2016), ranking it the third country with highest prevalence of diabetes globally (Guariguata, L., et al. 2014. Global estimates of diabetes prevalence for 2013 and projections for 2035. Diabetes research and clinical practice).

Diabetes is a life threatening conditions and is of major concern, the prevalence of diabetes is so high that American Diabetes Association (ADA) has ranked it to be the seventh leading cause of death in 2010 (American Diabetes Association, 2014). Diabetes not only takes toll of health of the population but also affects the economy of the country. According to a study, the total economic costs of diagnosed diabetes in US in 2012 was $245 billion (direct and indirect expenditure) and people with diabetes spend 2.3 times more money (in medical expenditure) than a person without diabetes (ADA, 2013). Diabetes is a multifactorial condition which can be genetic or environmental, majority of the cases of this condition are behavioral and environmental.

According to Food Allergy Research & Education (FARE) 15 million Americas have food allergies and among them 5% are adults and 8% are children. Researches have shown that number of people developing food allergies is growing and increased by 50% in children from 1997 to 2011 (FARE, 2016). FARE also puts eight food categories (milk, eggs, peanuts, tree nuts, soy, wheat, fish, and shellfish) that are accountable for 90% of the food allergies. Wheat is a dominant grain in the market and is in the top eight category of food allergies, thus creating a vacuum of food for people with allergies.

Wheat allergy and celiac disease are two different conditions but they have in common is wheat. Celiac disease (CD) is an autoimmune disorder that affects one in 141 Americans in which people cannot tolerate gluten because it damages the inner lining of their small intestine and prevents it from absorbing nutrients (Pietzak, M., 2012. Celiac Disease, Wheat Allergy, and Gluten Sensitivity When Gluten Free Is Not a Fad. Journal of Parenteral and Enteral Nutrition). Wheat contains gluten and hold risk to people with celiac. Studies have also found out that 10% of the people with Type 1 diabetes (T1D) has prevalence of celiac disease in comparison to 0.5% of the general population and also have common genetic precursors (ADA, 2014: Camarca, M. E., et al., 2012. Celiac disease in type 1 diabetes mellitus. Italian journal of pediatrics). It is known that T1D affects bone metabolism and structure and new studies have shown that CD is also an underlining cause in bone impairment (Camarca, et al., 2012). In short. osteopenia is a new phenomenon in people with CD, T1D or in two or more autoimmune diseases which can be managed with gluten free diet (Camarca, et al., 2012).

Food plays a vital role in a human's health and life in general. The health condition of people depends on what they put into their body therefore, food is one of the key component in solving health problems. According to CDC (2014), the majority of the U.S. adult population consumes less than the recommended amount of whole grains and dietary fiber on a daily basis, and less than 5 percent of Americans achieve the average recommended 3-ounce amount of whole grains per day. The USDA 2010 Dietary Guidelines recommend individuals to consume at least half of their grains as whole grain varieties and to replace refined grains with whole grains (McGuire, S. (2011). US Department of Agriculture and US Department of Health and Human Services, Dietary Guidelines for Americans). Food had negative as well as positive effects in the health of a person; some food tends to degrade the healthy condition where as other help promote health. There are many foods being researched and many more to be explored among them millets are the ones that have been ignored for decades.

Millets are small seeded species of cereal grains widely grown around the world and the sixth most important of the food grains. The nutrition composition of the millets are comparable to other cereals, moreover they are superior source in terms of dietary fiber, minerals, B-vitamins, starch properties and physiological action (Shobana, et al., 2013. Finger millet (Ragi, Eleusine coracana L.): a review of its nutritional properties, processing, and plausible health benefits. There are six types of most common and important millets. Amongst them finger millet is known to have the highest amount of calcium, potassium, sodium, dietary fiber and iron (Shobana, et al., 2013). While finger millet is high in many micronutrients and dietary fiber, it low in protein in comparison to wheat (e.g. finger millet at 7.3 g in comparison to 11.6 g of protein). Studies that have been conducted demonstrate that finger millet has properties to prevent and minimize incidence of disease along with potential health benefits in many conditions such as diabetes, cardio vascular disease, aging, cancer, celiac disease, cognitive development and many more. A beneficial effect on blood glucose and cholesterol regulation has also been demonstrated. The absence of gluten in the millet grain makes it a suitable substitute for people with celiac disease. However, millets contain no gluten, and therefore flour made from millet does not bind together well, creating significant challenges in creating formed food products such as tortillas, biscuits, cookies, and bread. Further, products made from millet may have a bitter off taste and off coloring, often disliked by consumers in the U.S.

A formulation and process is needed to produce a millet-based flour composition usable in making formed flour-based products that are nutritionally beneficial and acceptable to U.S. consumers, particularly those suffering health conditions such as diabetes and celiac disease.

### SUMMARY OF THE INVENTION

In a broad aspect, the present invention provides a composition and process formulation for production of millet-based flour that can be used to produce formed food products.

In one aspect, the composition and process formulation of the present invention may be used to produce multiple types of formed food products including, but not limited to tortillas, biscuits, pancakes, cookies, bread and snack-bars.

In another aspect, the distinctive combination of ingredients and process of the present invention provides high nutritional content and benefits that have the potential to: (1) lower blood glucose level in people with diabetes, (2) accelerate the wound healing process, (3) help regulate cholesterol levels, (4) provide a nutrient dense food useable by people with celiac disease and (5) prevent and minimize incidence of disease.

In a broad aspect, the present invention provides a formulation using two ancient and nutritional grains, finger millet and chickpea, to produce a nutrient dense flour that accompanies several essential health benefits derived from basic macro and micronutrients, the flour formulation comprising: finger millet flour, chickpea flour, sugar, and starch that can be combined with glycerin, baking powder, salt, olive oil, and water to produce formed food products.

In another aspect, the formulation of the present invention consists of optimized ingredients that substitute for the absence of gluten in the millet flour enabling binding in the formation of flour-based dough used to produce formed food products.

Another aspect, the formulation of the present invention includes chickpea flour to increase the protein content.

In another aspect, the formulation of the present invention includes food starch (e.g. rice, potato) replacing the absence of gluten in the flour to aid in binding to produce malleable dough when combined with water.

In another aspect, the formulation of the present invention may include gelatinized starches (rice and potato) to substitute for the absence of gluten.

In another aspect, the formulation of the present invention includes sugar to mask bitterness.

In another aspect, the flour formulation of the present invention may be combined with glycerine (food grade glycerin) to provide stability in formed food products.

In another broad aspect, the process of the present invention comprises: mixing finger millet flour and chickpea flour controlling particle size to within a specific range at 60 mesh, adding sugar and starch to produce nutrient dense flour that will bind together in malleable dough upon addition of and water, mixing, and kneading.

In another aspect, the nutrient dense flour formulation provided by the present invention can be used in making flatbread, tortillas, tortilla chips, and baked snack foods.

In another aspect, the nutrient dense flour formulation provided by the present invention may be combined with various flavorings and food components such as vanill, chocolate, nuts, and dried fruit to produce a ready-to-use baking mix.

In another aspect, the nutrient dense flour formulation provided by the present invention can be used as a substitute for wheat flour to produce foods such as waffles, pancakes, muffins, cookies and biscuits.

In another broad aspect, the present invention provides a method of constructing a malleable dough to produce nutrient dense flatbread, tortilla, tortilla chips, and baked snack foods, binding together finger millet flour and chickpea flour in controlled particle sizes within a specific range and adding starch, sugar, glycerin, olive oil, salt and water, followed by kneading, pressing and cooking the dough between heated plates.

### BRIEF DESCRIPTION OF THE FIGURES

FIG. 1 shows the process for producing a preferred embodiment of the millet-based flour as provided by the method of the present invention.

FIG. 2 presents steps for making an exemplary product (tortillas) using the millet-based flour produced by the process and formulation of the present invention.

FIG. 3 presents steps in processing and analyzing exemplary product (tortillas) made using millet-based flour provided by the present invention.

FIG. 4 shows absorbance of calcium in finger millet flour versus concentration of a standard solution.

FIG. 5 shows absorbance of calcium in chickpea flour versus concentration of a standard solution.

### DETAILED DESCRIPTION OF THE INVENTION

In brief: The unique blend in the millet-based flour created through our experimentation is nutrient dense, providing increased protein content in a gluten-free formulation. This optimized millet-based flour offers great possibility for prevention and management of diabetes through nutrition in populations that regularly consume wheat flour based products such as tortillas, bread and snack foods in their diet. Functional foods made using the millet-based flour formulation and process provided by the present invention may aid in management of Type 2 diabetes in a wide range of populations, with the outcome of improved health and lower healthcare costs. Being gluten-free, populations suffering gluten-intolerance or celiac disease may consume formed food products without suffering the negative effects produced by products that contain gluten.

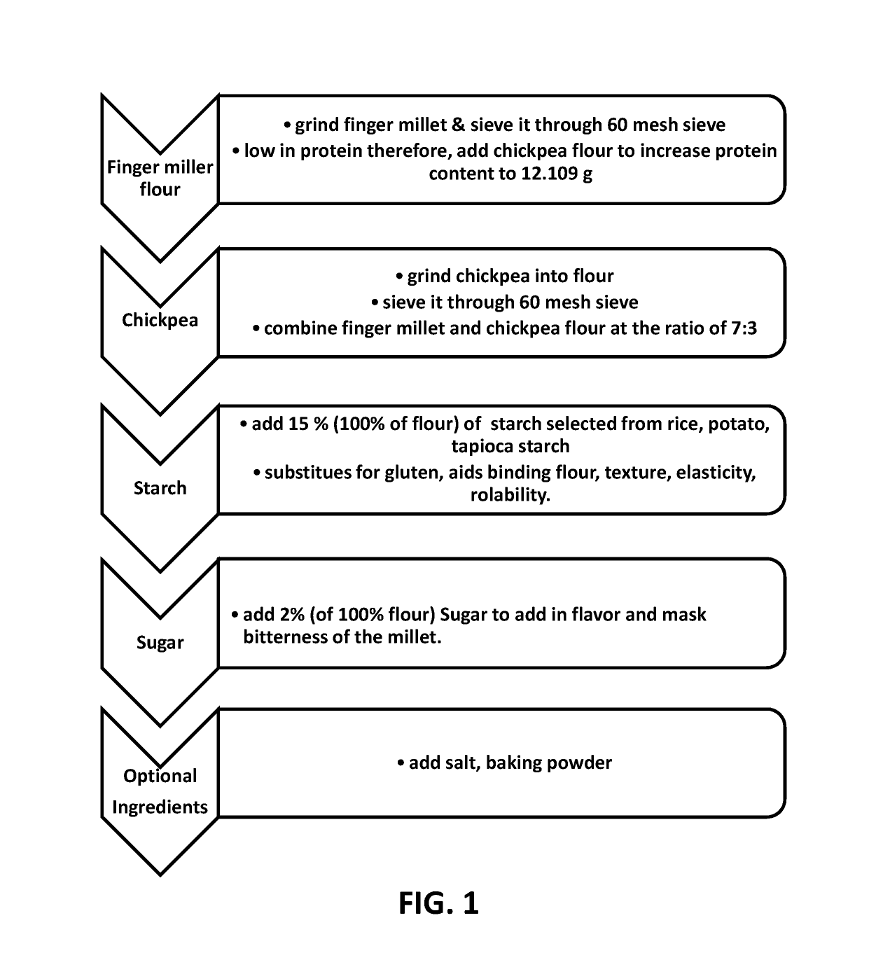

FIG. 1 shows the process for producing a preferred embodiment of the millet-based flour as provided by the present invention. Because the protein content in finger millet is lower than that of wheat (e.g., 7.3 g in comparison to 11.6 g), chickpea flour is added to finger millet flour at the ratio of approximately 70:30 w/w finger millet/chickpea to achieve 12.109 g of protein in order to reach a targeted protein content greater than wheat. Chickpeas and finger millet are ground to a substantially homogenous particle size and both the resulting flours are sieved through a 60 mesh sieve. (Commercially available [e.g. nuts.com] chickpea and finger millet flour may be substituted in this step.) This assures achieving a preferred particle size retaining most of the fiber as well as producing an improved texture of formed products (e.g., tortilla). Closely matching particle size between the flour components (chickpeas and finger millet) was found through experimentation to be an essential step to foster binding. To mask the bitterness of the finger millet, sugar is added to the mixture along with food starch to aid in binding. Salt may be included as well a baking powder. Experiments were conducted to determine the quantity of food starch required to replace gluten and aid in binding for the millet-based dough.

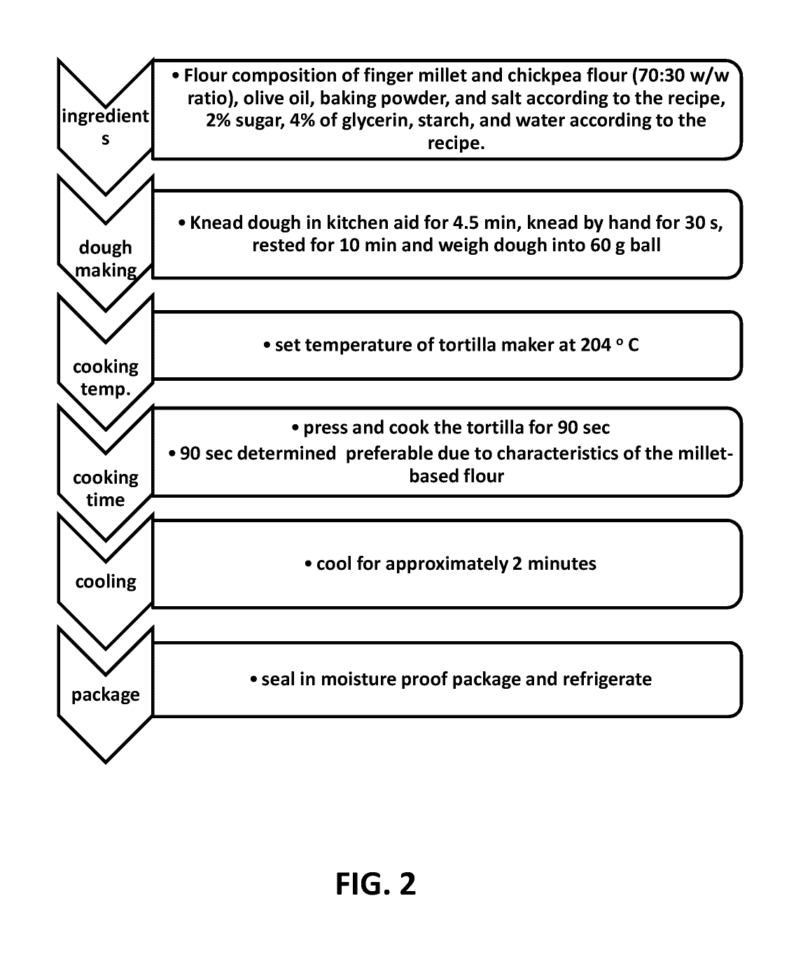

FIG. 2 presents steps of a preferred embodiment for making an exemplary product (tortillas) using the millet-based flour produced by the process and formulation of the present invention. The dry ingredients (finger millet flour, chickpea flour, starch, sugar, baking powder and salt) are mixed until a desired consistency is reached. The time period of mixing needed will vary based on the equipment used and the speed at which the equipment is operated. Mixing can be accomplished using industry standard mixers such as those available from KitchenAid. Olive oil and glycerine are added and mixed with the dry ingredients until no clumps are visible. Warm water (38° C.) is slowly added while mixing. The resulting dough is kneaded and then place in a sealed container in order to retain moisture. The dough may be weighed into 60 gram balls and stored in a sealed container during preparation. Industry standard equipment such as Cuisinart CPP-200 International chef tortilla maker can be used to press and bake tortillas at 204° C. The dough balls are placed in between the plates, and pressed and cooked. The cooked tortillas are set aside to rest and cooled for about 2 minutes which are then stored in moisture proof package.

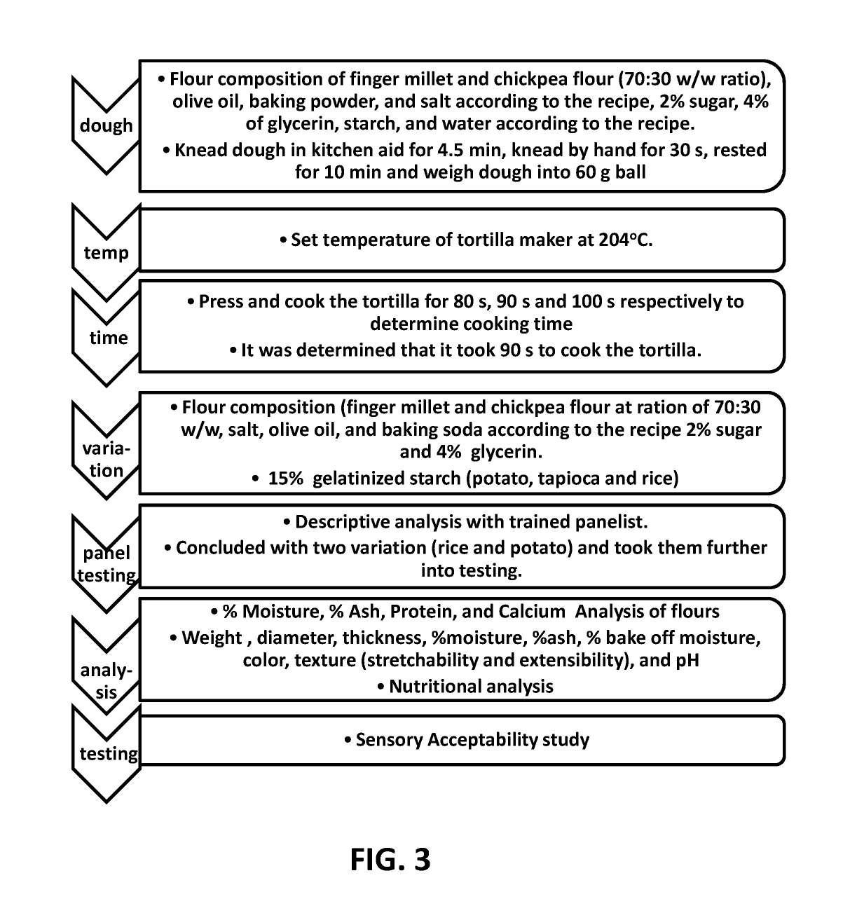

FIG. 3 presents the process of making and testing an exemplary product (tortillas) using the millet-based flour product of the present invention. Physico-chemical as well as sensory testing were conducted over the finished product to determine quality and consumer acceptability of the finished product. A descriptive analysis of the tortillas made with three different starch (rice, potato and tapioca) was done by a trained panelist. The result of the analysis eliminated tortillas with tapioca starch from a consumer prespective to due least likability among the three different tortillas. However, for other finished products (e.g., baked goods) tapioca or other food starches may be used and may produce acceptable results. The tortillas with rice and potato starch were further taken in for nutritional analysis and physico-chemical testing to determine their quality (i.e texture, color, appearance). Consumer testing was also conducted to gain insight on acceptability of the finished product.

In detail: The present invention provides a formulation using two ancient and nutritional grains, finger millet and chickpea, to produce a nutrient dense flour that accompanies several essential health benefits derived from basic macro and micronutrients, the flour formulation comprising: at least finger millet flour, chickpea flour, sugar, and starch that can be combined with glycerin, baking powder, salt, olive oil, and water to produce formed food products.

Referring FIG. 1, because the protein content in finger millet is lower than that of wheat (7.3 g in comparison to 11.6 g in equal volumes), in order to reach a targeted protein content, in a preferred embodiment of the present invention chickpea flour is added to finger millet flour at the ratio of approximately 70:30 w/w finger millet/chickpea to achieve a higher protein content than wheat flour (i.e, 12.109 g). Chickpeas are ground into flour for the purpose of mixing with finger millet flour. In order to get a homogenous particle size to enhance binding, both the flours are sieved through a 60 mesh sieve and combined with 15% of food starch. This produces a preferred particle size, while retaining most of the fiber. Experimental testing revealed that using a sieve greater than 60 mesh significantly diminished the fiber content of the flour. Using a sieve less than 60 mesh diminished binding. Also, the 60 mesh particle size was found through experimentation to produce a preferred texture in making a tortilla and support sufficient binding. To produce a formed food product, the millet-based flour of the present invention can be combined with at least one of vegetable oil (e.g. olive oil) and water. Glycerine may be added to enhance quality and obtain shelf-life stability of the product.

Experimental testing demonstrated that a tortilla can be produced substituting for wheat flour the millet-based flour of the present invention in proportions according to a tortilla recipe available from the US Department of Agriculture (USDA) at whatscooking.fns.usda.gov and incorporated herein by reference. To mask the bitterness of the millet, it was discovered through experimentation that adding approximately 2% sugar to the mixture was sufficient. Also, along with sugar, experimentation revealed that adding approximately 4% of glycerine (e.g., USP Vegetable Glycerin available from www.bulkapothecary.com) provided stability to the texture and tortilla product in general. Adding about 63% (in the tests 62.83% was measured) of water was found to be needed to form the dough for a tortilla. However, the percentage of water was varied according to specific recipes used to produce products other than tortillas (e.g., cookies, snack cakes). Such products may be cooked in a variety of ways, including baking or frying.

Referring to FIG. 2: To produce a tortilla using the millet-based flour of the present invention, the dry ingredients (finger millet flour, chickpea flour, starch, sugar, baking powder, and salt) in a preferred embodiment are mixed together and then liquid ingredients added to the mixture. It was found through experimentation that mixing dry ingredients for 1 minute and 30 seconds on speed 1 in an industry standard mixer (e.g., KitchenAid) was sufficient. The mixing time may vary when other types of mixers are used. Olive oil and glycerine are added and mixed. Experimentation revealed that mixing in liquid ingredients for a period of 45 seconds at speed 1 was sufficient. This may vary when other types of mixers are used. The sides of the mixing container should be scrapped down and the ingredients mixed further for another 45 seconds at speed 2 until no clumps are visible. Warm water (38° C.) should be slowly added while mixing at speed 1 and increasing to speed 3 for a total mixing time of 1 minute and 30 seconds. The dough should be kneaded for 30 seconds and then place in a sealed container in order to retain moisture. The dough may be weighed into 60 gram balls and stored in a sealed container during preparation. Equipment such as Cuisinart CPP-200 International chef tortilla maker can be used to press and bake tortillas at 204° C. In a preferred embodiment, the dough balls are placed in between the plates and pressed for 6 seconds and cooked for 1 min and 30 sec. The tortilla should be cooled on a cooling rack for 2 minutes and stored in a sealable bag.

### Experimentation & Formulation

An exemplary dough formula for a tortilla is provided in the following listing using a test mix of the millet-based flour of the present invention. Preferred ranges of ingredients are also shown.

| Ingredients | Test Mix | Preferred | More preferred |
|---|---|---|---|
| Finger millet flour | 144.2 g | 140 g-150 g | 144 g-145 g |
| Chickpea flour | 61.8 g | 58 g-65 g | 61 g-62 g |
| Baking powder | 3.5 g | 3 g-4 g | 3.4 g-3.6 g |
| Salt | 2.8 g | 2 g-3 g | 2.7 g-2.9 g |
| Starch | 30.9 g | 29 g-32 g | 30 g-31 g |
| Sugar | 4.1 g | 3.8 g-4.3 g | 4 g-4.2 g |
| Glycerin | 8.2 g | 8 g-8.4 g | 8.1 g-8.3 g |
| Oil | 16.2 g | 15.8 g-16.4 g | 16.1 g-16.3 g |
| Water | 170.7 g | 168 g-172 g | 170 g-171 g |

The flour formulation of the present invention may be used as a substitute for wheat flour in flour-based food compositions. The millet-based doughs made possible by the invention may be produced using any type of dough mixing apparatus known to those of skill in the art.

Referring to FIG. 3, one exemplary formulation process and method for mixing a dough in accordance with the invention was developed experimentally and tested for making tortillas. The equipment used in a food laboratory at the University of Central Oklahoma to make experimental dough formulations using the millet-based flour of the present invention is as follows:

Thermometer

Cuisinart tortilla maker

Kitchen aid mixer

Analytic balance

Measuring spoon

Measuring cups

Bowls

Airtight plastic containers

Plates

Aluminium foil

1-8 oz beaker

Rubber spatula

A plurality of compositions were formulated in attemps to produce a millet-based flour that would bind together sufficiently to support construction of formed food products. Many of the formulations attempted failed to produce satisfactory binding. A successful formulation and process was developed by focusing on producing a tortilla exhibiting charactistics supporting shaping and cooking. Other products produced included cookies and choclate brownies.

### Mixing Finger Millet Flour and Chickpea Flour

The protein content in finger millet is lower than that of wheat (7.3 g in comparison to 11.6 g in equal volumes), in order to reach higher targeted protein content, chickpea flour may be added at the ratio of 70:30 w/w to achieve 12.109 g of protein in 100 g of flour.

### Particle Size of the Flour

The optimum particle size of wheat flour is 100 mesh. An objective of experimentation was to determine a functional particle size for the finger millet and chickpea flour that would support binding while maintaining nutritional characteristics. Also, an objective was to match the size of the both the finger millet and chickpea flour to determine the particle size needed to get a homogenous flour that would produce a tortilla with characteristics acceptable to consumers. In initial trial tests the finger millet and chickpea flour was sieved through 100 mesh, doing so produced flour of a consistency similar to typical wheat flour, but eliminated a major amount of fiber from the finger millet and chickpea flour which is one of the key nutrients required to achieve objectives for millet-based flour provided by the present invention. Eliminating fiber also made binding of the tortilla even more difficult. In subsequent experimental trials the finger millet and chickpea flours were sieved through 100 mesh, 80 mesh, 60 mesh and 40 mesh sieves from each of which resulting flour mix tortillas were made according to the process of the present invention. This testing revealed that flour sieved through 60 mesh gave the best result in terms of product texture and functionality, while retaining most of the fiber as well. Using finger millet and chickpea flours sieved through 60 mesh resulted in a texturally better tortilla compared to flours produced using alternative mesh sizes.

### Addition of Sugar

Millet is not a widely consumed grain in United States although it is common in parts of Africa and India. The flavor characteristic of finger millet is very earthy and has a bitter aftertaste which might not be acceptable to U.S. consumers. Literature review revealed a research that used 15% of sugar by volume mixed into to a Sorghum flour (characteristically similar to millet flour) composition to mask the bitterness of Sorghum. For purposes of the present invention, a 15% sugar content was considered much higher than would be desirable for the intended consumers (e.g., diabetics). Experimentation was directed to minimizing the use of sugar, while sufficiently minimizing the bitter after taste of finger millet. A plurality of test formulations was used with different variations of sugar content. Experimentation with 15%, 10%, 5%, and 2% sugar content by volume respectively revealed that 2% sugar was sweet enough to mask the bitterness of the finger millet flour, but was not enough to convert the resulting tortilla into a “sweet” tortilla.

### Addition of Starch

Finger millet is a cereal grain that does not contain gluten which is beneficial as an alternative to wheat flour for patients with celiac disease, but absence of gluten inhibits the physiological properties of dough such as binding of the dough, rollability, and elasticity. To address this problem, test formulations included varied amounts of gelatinized starch from gluten free sources (rice, potato, tapioca). It was found that including gelatinized starch at 15% by volume sufficiently improved binding of the dough used to make tortillas, while keeping the product gluten free and suitable for patients with celiac disease. The amount of starch needed to make dough for other types of products may differ from the amount found useful for tortillas.

### Addition of Glycerine (Vegetable Glycerin)

Glycerine (a.k.a. Propylene glycol, Vegetable Glycerin) has a great effect on quality and shelf life of bread. Addition of propylene glycol reduces the quantity of water required to get suitable dough; significantly decreasing the moisture content making products more stable. According to one study, addition of 4% of polyols to a wheat flour containing ≧11.0% protein was acceptable, stable during storage and rollable (Suhendro, et al., 1995, Effects of polyols on the processing and qualities of wheat tortillas. Cereal Chemistry). Based on Suhendro's study 4% propylene glycol was added to various test formulations to lower moisture content, as well as make resulting products more stable. Addition of propylene glycol is known to extend shelf life of products and is expected to do so for food products produced using the millet-based flour of the present invention.

### Addition of Water

The amount of water required to form the tortilla in experimental formulations was derived from USDA's standardized tortilla recipe, i.e. 62.83% and found sufficient for use of the millet-based flour to produce tortillas.

### Kneading of Dough

We used a scientific method where the ingredients were mixed for various time periods up to 5 minutes and the results evaluated. The best outcome resulted when dry ingredients were mixed for 1 min and 30 sec and then oil and glycerine was added and mixed in for another 1 min and 30 sec and finally water was added to it and mixed for another 1 min and 30 sec. The mixed dough was then kneaded for 30 sec and stored in an air tight container to avoid loss of moisture. Alternative times for mixing may vary depending on the ingredients used and their specific characteristics. This process resulted in a functional dough.

### Cooking Time and Temperature of the Tortilla

There was no research found during literature searches on making a tortilla out of finger millet. The time and temperature required at which a tortilla should be cooked was unknown and was expected to vary depending on the method used. A plurality of tests was conducted to determine the time required to cook the tortillas made from the finger millet flour of the present invention at a given temperature without over cooking or undercooking. A mercury thermometer was used to measure the temperature of the tortilla maker used in experimentation, which temperature was 204 C. The cooking time for the tortillas was varied for 60 sec, 70 sec, 80 sec and 90 sec respectively. This experimentation revealed that the tortillas cooked to preferred quality at 204 C for 90 sec.

### Cooking Instrument

A Cuisinart tortilla maker was used throughout experimentation to make tortillas from the millet-based flour of the present invention. Since the tortilla composition of the present invention is gluten free, it was determined that the tortillas were not readily rollable. An alternative method found usable was to press the dough in between two heat plates to flatten it and cook at the same time. Experiments used a two-in-one press as well as the cooking plates to avoid breaking of the uncooked tortilla. This method was found to be satisfactory.

### Physical and Chemical Measurements

### Moisture, Ash and Protein Content of Finger Millet Flour and Chickpea Flour

Table 1 shows the average moisture, ash and protein content of finger millet flour, chickpea flour, potato starch, and rice starch. There was no significant difference in moisture content of the flours, but there were significant differences in ash and protein content. The ash of chickpea flour was higher that finger millet flour which shows there is higher quantity of minerals in chickpea flour in comparison to finger millet flour. The data for potato starch and rice starch was obtained from their manufacturer.

TABLE 1
Comparison of moisture, ash and protein content results
of finger millet flour and chickpea flour *

| Sample | Moisture (%) | Ash (%) | Protein (%) |
|---|---|---|---|
| Finger millet flour | 10.7 ± 0.09^{a} | 1.83 ± 0.13^{a} | 5.2 |
| Chickpea flour | 10.3 ± 0.11^{a} | 2.41 ± 0.31^{b} | 19.7 |
| Potato Starch | 4% | 0.21% | <0.1% |
| Rice Starch | 12% | 0.24% | 0.43% |

* Means ± standard deviation with different superscripts within columns indicate significant differences among treatments (p < 0.05).

### Weight, Diameter, Thickness and Bake Off Moisture Percentage

Table 2 shows the averages for weight, diameter, and thickness of two sample tortillas made with chickpea fortified finger millet flour. There was significant difference in weight and diameter but no significant differences in thickness of the tortillas. The weight of the tortillas is indirectly proportional to the bake off moisture % of the tortillas. The bake off moisture % of T-RICE tortilla made with rice is higher than T-POTATO tortilla made with potato which shows that more moisture (liquid) is baked off in the process of making the tortilla in comparison to T-POTATO. The moisture bake off from the tortilla is also a characteristic of starch, it shows that potato starch absorbs and holds more water than rice starch. The potato starch has larger, irregular granules and higher content of phosphate group in comparison to rice starch which aids in higher swelling power without disintegration. The diameter and the thickness of the tortillas are indirectly proportional; higher the diameter co-relates to lower thickness due to the spreadability of the tortillas. T-RICE made with rice had higher spreabability with higher diameter and lower thickness.

TABLE 2
Comparison of weight, thickness and diameter results of chickpea
fortified finger millet tortillas with different starches*.

| | Weight (g) | Thickness (mm) | Diameter (mm) | Bake off moisture (%) |
|---|---|---|---|---|
| T-RICE¹ | 46.50 ± 0.39^{a} | 3.28 ± 0.36^{a} | 144.79 ± 2.19^{a} | 33.5 |
| T-POTATO² | 49.25 ± 0.94^{b} | 3.61 ± 0.09^{a} | 133.51 ± 3.12^{b} | 28.0 |

*Means ± standard deviation with different superscripts within columns indicate significant differences among treatments (p < 0.05).
¹Chickpea fortified finger millet tortilla with rice starch.
²Chickpea fortified finger millet tortilla with potato starch.

### Moisture Content, Ash and pH

Table 3 shows the average moisture content, ash and pH of two chickpea fortified finger millet tortilla sample. There was no significant difference in moisture content, ash or pH of the sample tortilla. These results were expected as two samples differ only with respect to starch. The composition of starches is very similar consisting of polymers and minor compound however the physio-chemical properties and functional characteristics were prepared in an aqueous system and annealing could occur during heating.

TABLE 3
Comparison of moisture and ash results of chickpea fortified
finger millet tortillas with different starches*

| Sample | Moisture % | Ash % | pH |
|---|---|---|---|
| T-RICE¹ | 26.4 ± 0.09^{a} | 2.86 ± 0.07^{a} | 6.48 ± 0.08^{a} |
| T-POTATO² | 26.6 ± 0.04^{a} | 2.86 ± 0.03^{a} | 6.48 ± 0.02^{a} |

*Means ± standard deviation with different superscripts within columns indicate significant differences among treatments (p < 0.05).
¹Chickpea fortified finger millet tortilla with rice starch.
²Chickpea fortified finger millet tortilla with potato starch.

### Color

Table 4 shows the average ‘L’, ‘a’, and ‘b’ values which were significantly different in both the samples. The tortillas T-POTATO made with potato starch were lighter in color in comparison to T-RICE made with rice starch with a ‘L’ value of 57.1. The values of ‘a’ were higher in T-RICE which indicates that it has more redness and as for values of ‘b’ T-POTATO is higher which shows it has more yellow color. The higher phosphate monoester content in potato starch results in pastes with higher light transmittance, whereas higher phospholipids in cereal starch (rice) results in pastes with lower transmittance. The transmittance properties of the starches explain the lighter color of tortillas with potato starch in comparison to tortillas with rice starch. A maillard reaction occurred between potato starch and lysine resulting in higher yellowness, which explains the yellower color of tortillas with potato starch in comparison to tortillas with rice starch.

TABLE 4
Comparison of color results of chickpea fortified
finger millet tortillas with different starches*

| Sample | L | a | b |
|---|---|---|---|
| T-RICE¹ | 52.56 ± 0.99^{a} | 8.32 ± 0.15^{a} | 16.64 ± 0.33^{a} |
| T-POTATO² | 57.09 ± 1.41^{b} | 7.82 ± 0.39^{b} | 17.62 ± 0.83^{b} |

*Means ± standard deviation with different superscripts within columns indicate significant differences among treatments (p < 0.05).
¹Chickpea fortified finger millet tortilla with rice starch.
²Chickpea fortified finger millet tortilla with potato starch.

### Texture (Stretchability and Extensibility)

T-RICE tortillas made with rice starch had significant higher force meaning they were firmer but had insignificant difference in distance with only a slightly higher distance indicating only slight extensible. A higher force indicates greater stretchability, the higher force on T-RICE suggests that it has the higher stretchability in comparison to T-POTATO tortillas with potato starch. However, gluten-network in wheat tortillas creates flexibility so, the stretchability test may not be a good indicator for a gluten-free tortilla due to the absence of gluten-network.

Table 5 shows the average force and distance of the tortillas testing its extensibility. There was significant different for force and distance with the lowest value of 1184.93 g. A low force value and longer distance of extension indicates soft and extensible tortillas, whereas higher force value and shorter rupture distance indicates hard and brittle tortillas. T-RICE made with rice has low force and longer distance whereas T-POTATO made with potato has higher force and shorter distance making indicating T-RICE being softer than T-POTATO.

TABLE 5
Comparison of extensibility and strechability texture results of chickpea
fortified finger millet tortillas with different starches*

| | Extensibility | | Strechability | |
|---|---|---|---|---|
| Sample | Force (g) | Distance (mm) | Force (g) | Distance (mm) |
| T-RICE¹ | 1184.93 ± 125.288³ | 17.35 ± 1.81^{a} | 424.6 ± 38.31^{a} | 3.92 ± 0.75^{a} |
| T-POTATO² | 1427.77 ± 245.65^{b} | 14.63 ± 0.59^{b} | 372.14 ± 53.77^{b} | 3.82 ± 1.09^{a} |

*Means ± standard deviation with different superscripts within columns indicate significant differences among treatments (p < 0.05).
¹Chickpea fortified finger millet tortilla with rice starch
²Chickpea fortified finger millet tortilla with potato starch

### Calcium Analysis

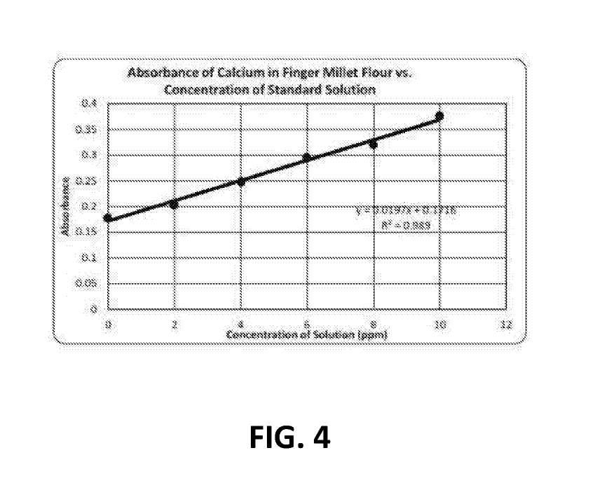

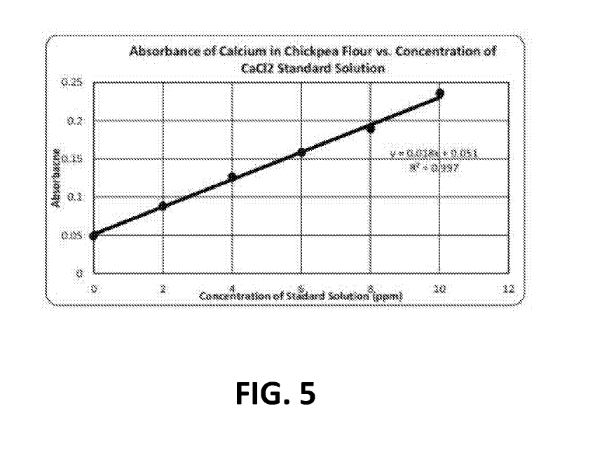

The calcium analysis using Flame Atomic Absorption (FAA) showed that finger millet has 43.553 mg of calcium per 100 g and chickpea has 14.167 mg per 100 g. Absorbance of calcium in finger millet flour versus concentration of a standard solution (see FIG. 4) was shown to be substantially linear in a range of solution concentration from 0 to 10 ppm, rising from approximately 0.18 to 0.38. Absorbance of calcium in chickpea flour versus concentration of a standard solution (see FIG. 5) was shown to be substantially linear in a range of solution concentration from 0 to 10 ppm, rising from approximately 0.05 to 0.24.

### Nutrition

There was no significant difference in nutritional facts of the tortillas tested since the only difference in the formulation was the use of different starch which had similar properties. The composition of starches is very similar consisting of polymers and minor compound however the physio-chemical properties and functional characteristics is subjected to aqueous system, biological origin and annealing.

### Sensory Analysis

Sensory evaluation of tortillas made using the millet-based flour of the present invention was conducted at University of Central Oklahoma in two different evaluations. A descriptive analysis of 3 sample tortillas was accomplished by a trained panel (dietetic interns and graduate students), the result of the analysis lead to elimination of one sample. The remaining two samples were taken further into additional testing and sensory acceptance study. Subsequent sensory acceptance study was conducted by students and staff. Institutional Review Board's (IRB) approval was granted for all stages of this study through University of Central Oklahoma.

### Descriptive Analysis

Table 6 shows the only significant difference in flavor was in sweetness and doughy after taste of the tortillas tested. The tortillas with potato starch were the sweetest compared to the tortillas made with tapioca starch which has an average score of 1.4 (least sweet comparable to 0.465 or sucrose solution). The doughy profile was high (5.5 score comparable to butter roll) for tortillas with potato starch while the scores were similar for tortillas with rice or tapioca starch. Overall the highest acceptance scores were observed on tortillas with potato starch compared to those with rice or tapioca starch.

TABLE 6
Comparison of flavor attributes in description analysis of chickpea
fortified finger millet tortillas with different starches*

| | Flavor | | | | |
|---|---|---|---|---|---|
| Sample | Sweet ^{I} | Salty ^{II} | Nutty ^{III} | Bitter ^{IV} | Doughy ^{V} |
| T-RICE¹ | 1.6 ± 0.74^{a} | 2.3 ± 0.71^{a} | 6.5 ± 2.62^{a} | 1.3 ± 0.71^{a} | 2.9 ± .099^{a} |
| T-POTATO² | 2.6 ± 0.92^{b} | 2.6 ± 1.51^{a} | 6.1 ± 3.18^{a} | 1.0 ± 0.00^{a} | 5.5 ± 2.56^{b} |
| T-TAPIOCA³ | 1.4 ± 0.52^{a} | 1.8 ± 0.89^{a} | 5.6 ± 2.20^{a} | 2.0 ± 1.77^{a} | 3.0 ± 1.69^{a} |

*Means ± standard deviation with different superscripts within columns indicate significant differences among treatments (p < 0.05).
¹Chickpea fortified finger millet tortilla with rice starch.
²Chickpea fortified finger millet tortilla with potato starch.
³Chickpea fortified finger millet tortilla with tapioca starch.
^{I} Sweet intensity was evaluated on a scale from 1 (not detectable) to 15 (extremely sweet)
^{II} Salty intensity was evaluated on a scale from 1 (not detectable) to 15 (extremely salty)
^{III} Nutty intensity was evaluated on a scale from 1 (not detectable) to 15 (extremely nutty)
^{IV} Bitter intensity was evaluated on a scale from 1 (not detectable) to 15 (extremely bitter)
^{V} Doughy intensity was evaluated on a scale from 1 (not detectable) to 15 (extremely doughy)

Table 7 shows in attributes of texture, there was no significant difference across the parameters both in hand and mouth feel texture. But the scores for roughness and tearbility was slightly higher for tortillas made with potato starch which correlates with the physicochemical texture data that indicated it is harder in comparison to tortilla with rice starch.

TABLE 7
Comparison of texture attributes in description analysis of chickpea
fortified finger millet tortillas with different starches*

| | Texture | | | | |
|---|---|---|---|---|---|
| | Texture (in hand) | | | Texture (by mouth) | |
| Sample | Roughness ^{I} | Tearability ^{II} | Hardness ^{III} | Fracturability ^{IV} | Grittiness ^{V} |
| T-RICE¹ | 5.5 ± 1.07^{a} | 12.3 ± 2.38^{a} | 8.6 ± 3.96^{a} | 7.3 ± 3.20^{a} | 5.6 ± 3.99^{a} |
| T-POTATO² | 6.1 ± 2.90^{a} | 12.5 ± 2.14^{a} | 5.8 ± 1.66^{a} | 5.9 ± 2.85^{a} | 3.1 ± 1.45^{a} |
| T-TAPIOCA³ | 5.4 ± 1.19^{a} | 12.4 ± 1.77^{a} | 7.9 ± 3.39^{a} | 6.4 ± 2.19^{a} | 5.0 ± 3.07^{a} |

*Means ± standard deviation with different superscripts within columns indicate significant differences among treatments (p < 0.05).
¹Chickpea fortified finger millet tortilla with rice starch.
²Chickpea fortified finger millet tortilla with potato starch.
³Chickpea fortified finger millet tortilla with tapioca starch.
^{I} Roughness intensity was evaluated on a scale from 1 (not detectable) to 15 (extremely rough)
^{II} Terability intensity was evaluated on a scale from 1 (easily pulled apart) to 15 (extremely hard to pull apart)
^{III} Hardness intensity was evaluated on a scale from 1 (extremely easy to bite down) to 15 (extremely hard to bite down)
^{IV} Fracturability intensity was evaluated on a scale from 1 (extremely easy break) to 15 (extremely hard to break)
^{V} Grittiness intensity was evaluated on a scale from 1 (absence of gritty particles) to 15 (extremely presence of gritty particles)

Table 8 shows shape is an attribute that has significant difference in context of appearance of the tortillas tested. The tortillas with rice starch were rounder than other tortillas with a high score of 14.1. The data indicates that tortillas made with rice starch and tortillas made with tapioca starch were rounder and smoother than tortilla with potato starch.

TABLE 8
Comparison of appearance attributes in description analysis of chickpea
fortified finger millet tortillas with different starches*

| | Appearance | | |
|---|---|---|---|
| Sample | Evenness of the color ^{I} | Shape ^{II} | Surface ^{III} |
| T-RICE¹ | 9.8 ± 3.73^{a} | 14.1 ± 0.35^{a} | 6.0 ± 2.97^{a} |
| T-POTATO² | 8.3 ± 3.77^{a} | 8.6 ± 3.02^{b} | 6.5 ± 3.33^{a} |
| T-TAPIOCA³ | 11.3 ± 2.12^{a} | 12.5 ± 2.5 ^{a} | 5.6 ± 2.06^{a} |

*Means ± standard deviation with different superscripts within columns indicate significant differences among treatments (p < 0.05).
¹Chickpea fortified finger millet tortilla with rice starch.
²Chickpea fortified finger millet tortilla with potato starch.
³Chickpea fortified finger millet tortilla with tapioca starch.
^{I} Evenness of the color intensity was evaluated on a scale from 1 (very even) to 15 (extremely uneven)
^{II} Shape intensity was evaluated on a scale from 1 (not round) to 15 (perfectly round)
^{III} Surface intensity was evaluated on a scale from 1 (presence of blistering) to 15 (absence of blistering)

Table 9 shows in aspect of odor and overall likability there was no significant difference in the tortillas tested, but the scores indicated that tortillas made with tapioca starch, tortillas made with rice starch, and tortillas made with potato starch had least sweet and musty odor, respectively. Panelists preferred tortillas made with potato starch with an overall likability scores of 11.1 and disliked tortillas made with tapioca starch with the least score of 6.9.

TABLE 9
Comparison of odor and overall likability attributes
in description analysis of chickpea fortified finger
millet tortillas with different starches*

| | Odor and Overall likability | | |
|---|---|---|---|
| Sample | Sweet ^{I} | Musty ^{II} | Overall likability ^{III} |
| T-RICE¹ | 2.0 ± 1.07^{a} | 6.8 ± 2.36^{a} | 9.3 ± 2.76^{a} |
| T-POTATO² | 2.1 ± 1.46^{a} | 5.8 ± 3.69^{a} | 11.1 ± 3.72^{a} |
| T-TAPIOCA³ | 1.8 ± 1.49^{a} | 7.3 ± 2.76^{a} | 6.9 ± 4.32^{a} |

*Means ± standard deviation with different superscripts within columns indicate significant differences among treatments (p < 0.05).
¹Chickpea fortified finger millet tortilla with rice starch.
²Chickpea fortified finger millet tortilla with potato starch.
³Chickpea fortified finger millet tortilla with tapioca starch.
^{I} Sweet intensity was evaluated on a scale from 1 (not detectable) to 15 (extremely sweet)
^{II} Musty intensity was evaluated on a scale from 1 (not detectable) to 15 (extremely musty)
^{III} Overall likability intensity was evaluated on a scale from 1 (extremely dislike) to 15 (extremely like)

### Sensory Acceptance Study

Table 10 shows the average scores from the consumer acceptability test. Appearance is the only attribute that has significant difference with a score of 6.3 for tortilla with rice starch and 5.6 for tortilla with potato starch. The overall likability score for tortilla with potato starch were slightly higher in comparison to tortilla with rice starch which correlates with higher score in taste, aroma and texture. In contrast, the appearance and the tenderness score were low for tortilla with potato starch which correlates with it being smaller, thicker and tougher tortillas from physicochemical testing. According to Wani et al., (2012), rice starch has bland taste, smooth, creamy and spreadable characteristics which corresponds with lower scores in taste but higher scores in appearance and tenderness of the tortillas with rice starch.

TABLE 10
Comparison of scores from consumer acceptance study of chickpea
fortified finger millet tortillas with different starches*

| | Overall | | | | | |
|---|---|---|---|---|---|---|
| Sample | likeability | Appearance | Texture | Tenderness | Aroma | Taste |
| T-RICE¹ | 6.0 ± 1.77^{a} | 6.3 ± 1.51^{a} | 5.8 ± 1.68^{a} | 6.0 ± 1.76^{a} | 5.9 ± 1.39^{a} | 5.9 ± 1.82^{a} |
| T-POTATO² | 6.3 ± 1.7^{a} | 5.6 ± 1.70^{b} | 6.0 ± 1.75^{a} | 5.9 ± 1.93^{a} | 6.1 ± 1.51^{a} | 6.0 ± 1.87^{a} |

*Means ± standard deviation with different superscripts within columns indicate significant differences among treatments (p < 0.05).
¹Chickpea fortified finger millet tortilla with rice starch
²Chickpea fortified finger millet tortilla with potato starch

### Ready to Use Millet-Based Flour

The present invention provides a formulation using two ancient and nutritional grains, finger millet and chickpea, to produce a nutrient dense flour that accompanies several essential health benefits derived from basic macro and micronutrients. The millet-based flour formulation comprising at least finger millet flour, chickpea flour, sugar, and starch can be combined with glycerin, baking powder, salt, olive oil, and water to produce formed food products. A “ready-to-use” flour product can be made using the methods and formulations of the present invention that can substitute for at least wheat flour in producing formed food products. This “ready to use” flour product composition made in accordance with the process and formulation of the present invention includes at least finger millet flour, chickpea flour, sugar, starch, baking powder, and optionally salt in substantially the same ratios as the experimental formulations disclosed herein. The “ready-to-use” flour product may be packaged in the same types of enclosures used for common wheat flour or other “ready-to-use” baking products such as wheat-based Bisquick®. The “ready-to-use” flour product provided by the process and formulation of the present invention may be used in creating formed food products including but not limited to tortillas, biscuits, pancakes, waffles, cookies, bread, and snack foods. The “ready-to-use” flour product provided by the present invention may be combined with various flavorings and food components such as chocolate, nuts, and dried fruit to produce a ready-to-use baking mix, such as but not limited to a cake mix, muffin mix, or brownie mix.

The skilled artisan will appreciate that the present invention is suitable for use in producing a flour usable in making a variety of formed food products, and is not limited by the specific examples cited herein. While particular emphasis has been directed towards experimental results obtained by mixing ingredients to produce a tortilla, the skilled artisan will appreciate that the present invention is also suitable for use in mixing a dough usable to produce functional foods that would typically use wheat flour or flour made from another type of grain. Further, the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A formulation and process providing a method for producing millet-based flour, comprising:
mixing millet flour and chickpea flour in approximately a 70 to 30 w/w ratio, respectively;
matching the particle size of said millet flour and said chickpea flour by sieving through mesh in the range of 40 to 100 and preferably 60 mesh;
adding sugar to said millet flour and chickpea flour in the range of 0.01 to 3% and preferably between 1.9 to 2.1% (of 100% flour) to mask bitterness;
adding starch derived from at least one of rice, potato, tapioca in the range of 10% to 20% and preferably 15% (of 100% flour) to enable binding together of said millet flour and said chickpea flour when mixed with at least water to form a dough and the dough kneaded.

2. The formulation and process of claim 1, wherein chickpea flour is added in an amount required to elevate the protein content of said millet-based flour above 10 grams per 100 grams of flour.

3. The formulation and process of claim 1, wherein sieving is through 60 mesh to produce an optimum particle match between said millet flour and said chickpea flour while retaining most of the fiber.

4. The formulation and process of claim 1, wherein said millet flour comprises finger millet.

5. A specialty flour comprising:
finger millet flour and chickpea flour in approximately a 70 to 30 w/w ratio sieved in the range of 40 to 100 mesh and preferably through 60 mesh;
sugar in the range of 0.01 to 3% and preferably between 1.9 to 2.1% (of 100% flour); and
starch derived from any gluten free source including any of rice, potato, tapioca in the range of 10% to 20% and preferably 15% (of 100% flour),
wherein said specialty flour is usable to produce multiple types of formed food products including any of tortillas, biscuits, pancakes, waffles, cookies, bread, and snack foods.

6. The specialty flour of claim 5, further comprising at least one of baking powder and salt.

7. The specialty flour of claim 5, wherein said flour is packaged as a ready-to-use mix.

8. The specialty flour of claim 6, wherein said flour is packaged as a ready-to-use mix.

9. The specialty flour of claim 6, wherein said flour is combined with various flavorings and food components including any of spice, vanilla, chocolate, nuts, and dried fruit to produce a ready-to-use baking mix.

10. A method of constructing a malleable dough usable to produce nutrient dense functional foods, the method comprising:
mixing a flour consisting of at least finger millet flour, chickpea flour, sugar, and food starch with propylene glycol and water, said finger millet flour and chickpea flour being combined in approximately a 70 to 30 w/w ratio and sieved in the range of 40 to 100 mesh and preferably through 60 mesh, said sugar comprising less than 15% and preferably between 1.9 to 2.1%, by weight of 100% flour, said food starch derived from any gluten free source including any of rice, potato, tapioca in the range of 10% to 20% and preferably 15% of 100% flour, said propylene glycol being in the range of 3% to 5% and preferably 4% (of 100% flour),
wherein said water exhibits a temperature in the range of 35° C. to 40° C. and preferably at approximately 38° C. and is mixed with said flour for a total mixing time of less than 5 minutes and preferable between 1 to 3 minutes, and
wherein the resulting mixture is kneaded to produce said malleable dough.

11. The method of claim 10, wherein said malleable dough is shaped into various forms required to produce any of flatbread, tortillas, tortilla chips, pancakes, waffles, bread, and baked or fried snack foods.

12. The method of claim 10, further comprising adding vegetable oil.

13. The method of claim 12, wherein said malleable dough is shaped into various forms required to produce any of flatbread, tortillas, tortilla chips, pancakes, waffles, bread, and baked or fried snack foods.

14. The method of claim 12, where in said vegetable oil is olive oil.

15. The method of claim 14, wherein said malleable dough is shaped into various forms required to produce any of flatbread, tortillas, tortilla chips, pancakes, waffles, bread, and baked or fried snack foods.
